(19) United States
(12) Patent Application Publication
(10) Pub. No.: US 2010/0282964 A1
(43) Pub. Date: Nov. 11, 2010

(54) METHODS AND APPARATUSES TO ALIGN ENERGY BEAM TO ATOM PROBE SPECIMEN

(76) Inventors: Joseph Hale Bunton, Madison, WI (US); Jesse D. Olson, Madison, WI (US); Roger Alvis, Virgina Beach, VA (US); Daniel R. Lenz, Madison, WI (US); Ed Oltman, Madison, WI (US)

Correspondence Address: Intellectual Property Dept.;Dewitt Ross & Stevens SC, 2 East Mifflin Street, Suite 600, Madison, WI, 53703-2865, US

(21) Appl. No.: 12/676,314

(22) PCT Filed: Aug. 27, 2008
(86) PCT No.: PCT/US2008/074501

§ 371 Date: Jun. 25, 2010

Related U.S. Application Data
(60) Provisional application No. 60/969,892, filed on Sep. 4, 2007.

(51) Int. Cl. H01J 49/26; H01J 49/00

(52) U.S. Cl. 250/282

(57) ABSTRACT

A method for aligning an energy beam to an object in an atom probe is disclosed. The method comprises monitoring at least one parameter indicative of an interaction between the energy beam and the object. A signal is generated in response to the interaction of the energy beam and the object. The signal is then used to effectuate control of the alignment of the energy beam to the object.

### CROSS-REFERENCE TO RELATED APPLICATION(S)

This application claims the benefit of U.S. Provisional Patent Application No. 60/969,892, filed Sep. 4, 2007, entitled METHODS AND APPARATUSES TO ALIGN ENERGY BEAM TO ATOM PROBE SPECIMEN, which is incorporated herein by reference.

### TECHNICAL FIELD

The present disclosure is related generally to methods and apparatuses for aligning energy beams to atom probe specimens.

### BACKGROUND

An atom probe (e.g., atom probe microscope) is a device which allows specimens to be analyzed on an atomic level. For example, a typical atom probe includes a specimen mount, an electrode, and a detector. One difficulty associated with such a probe is a loss of alignment between the specimen held at the specimen mount and other components of the probe (e.g., the electrode and/or the detector). The loss of alignment for any reason can result in a number of problems including (1) that a shift in beam focus or beam position may require higher beam power to generate equivalent absorption of beam energy by the specimen; (2) a reduction in evaporation rate, hence longer acquisition times; and (3) a failure to evaporate any ions, hence termination of acquisition.

### BRIEF DESCRIPTION OF THE DRAWINGS

FIG. 1 is a schematic illustration of an energy beam focus and beam positioning system in accordance with a disclosed embodiment.

FIGS. 2A, 2B and 2C are schematic illustrations of a laser alignment path, a representation of misalignment, and a representation of a realigned laser spot in accordance with a disclosed embodiment.

FIG. 3 is a flowchart of steps taken to align, monitor, and maintain laser alignment in accordance with a disclosed embodiment.

FIG. 4 is a schematic illustration of a laser beam position sensing system utilizing photodiodes and amplifiers in accordance with a disclosed embodiment.

FIG. 5 is a plot of the Evaporation percent (Er) versus position with a peak percentage at approximate coordinates of −88.0, +302 (x,y) microns (um).

FIGS. 6A and B are a graph of the number of counts versus the mass to charge ratio with an indication that a portion of the spectrum is utilized for a control signal and a flowchart indicating decisions made to identify a portion of the spectrum utilized for a control signal.

FIG. 7 is a flowchart of possible modes of operation included in the alignment process.

### DETAILED DESCRIPTION

Although for the purpose of illustration, many of the following embodiments are discussed with reference to laser pulsed atom probes, one skilled in the art will understand that the underlying principles are equally applicable to any pulsed energy beam.

According to conventional techniques, a typical atom probe includes a specimen mount, an electrode, and a detector. During analysis, a specimen is carried by the specimen mount and a positive electrical charge (e.g., a baseline voltage) is applied to the specimen. The detector is spaced apart from the specimen and is either grounded or negatively charged. The electrode is located between the specimen and the detector, and is either grounded or negatively charged. The relative position and orientation of the components and the polarity of the voltages applied to the aforementioned components creates an electric field between components at different voltages. A positive electrical pulse (above the baseline voltage) and/or a laser pulse (e.g., photonic energy) are intermittently applied to the specimen. Alternately, a negative voltage pulse can be applied to the electrode. Occasionally (e.g., one time in 100 pulses) a single atom is ionized near the tip of the specimen. The ionized atom(s) separate or “evaporate” from the surface, pass though an aperture in the electrode, and impact the surface of the detector resulting in a detected ion, resulting in a “count”. The elemental identity of an ionized atom can be determined by measuring its time of flight (TOF) between the surface of the specimen and the detector, which varies based on the mass/charge ratio of the ionized atom. The location of the ionized atom on the surface of the specimen can be determined by measuring the location of the atom's impact on the detector. Accordingly, as the specimen is evaporated, a three-dimensional map of the specimen's constituents can be constructed.

Evaporation rate (Er), defined as the number of ions detected per unit excitation pulse, is a primary metric used to control/monitor the atom probe data collection process. Failure to accurately monitor or control Er can result in either little or no data being collected (Er˜0) or too many ionization events detected. Additionally, if the induced electric field is too great, the specimen can fracture, damaging the specimen and possibly other atom probe components, or may spontaneously emit ions with indeterminate flight times in a process known as dc evaporation. Furthermore, if the Er is too high where multiple ions are liberated or evaporated on the same pulse, data “noise” can result because the detected ions cannot be properly correlated in time with the ionizing pulse. This can lead to mass resolution problems and data degradation (see e.g., Miller, M. K. Atom Probe Tomography, Analysis at the Atomic Level, which is fully incorporated herein by reference).

The excitation pulse(s) can include various forms of energy and can include varying pulse rates. For example, in certain embodiments the excitation pulse(s) can include one or more of the following: an electron beam or packet, an ion beam, a laser pulse, or some other suitable pulsed source. If the pulse energy and the induced electric field are sufficient, then ionization can occur. Thus, even excitation pulses that have sufficient energy, but are not optimally aligned to the specimen can result in ionization. One of the results of ionization from poorly aligned beams includes but is not limited to surface migration of ions resulting in contamination of the mass/charge spectrum. Another result of a poorly aligned beam can be a strong degradation in mass resolution. If the beam is aligned further down the shank of a specimen, away from the apex, then a larger mass can be heated thus requiring more time to cool. Alternately, materials with poor thermal diffusivity can take longer to heat up. Either of these conditions can result in an increased spread of ion departure times, hence an increased spread in ion flight times, or TOF's. A wider distribution of TOF's for a given mass to charge ratio degrades the mass resolution.

In addition, the atom probe typically includes some cryogenic cooling means. Cooling of the specimen is necessary to reduce thermal motion at the atomic level that can result in positional errors in the data collected. Temperatures on the order of 100K are not uncommon. These temperature differentials between the specimen and the surrounding components can cause physical drift in the position of the specimen or components over the course of an atom probe measurement. The drift can manifest itself as a loss of alignment between the laser beam and the desired location of the beam focus on the specimen.

Other sources of drift include but are not limited to movement of the tip due to specimen stage drift, specimen erosion, or specimen bending due to the electric field. The specimen is typically mounted on a micropositioner and some shifting may occur during the atom probe measurement. As the ions are field evaporated the apex of the specimen erodes, hence the beam needs to track the evolving tip. Some specimens (including silicon) may also change their physical orientation (i.e. bend) as the tips erodes, the standing voltage changes, and the induced electric field changes. As a result, merely aligning the laser beam to the specimen is difficult due to the dimensions involved. Typical specimens are on the order of 50 to 100 microns tall and are formed into a sharp tip with a radius of curvature between 50 to 100 nanometers. Typical laser spot sizes are about 5 microns in diameter.

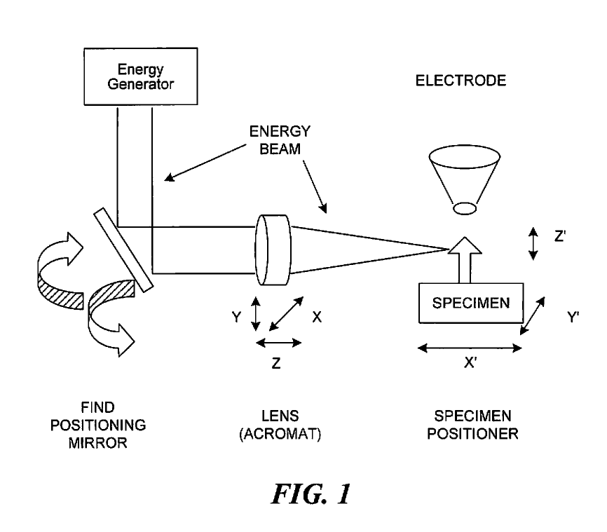

Using conventional alignment techniques (as disclosed in PCT Application No. US2004/026823, Attorney Docket No. 39245-8109. WO00, filed Aug. 19, 2004, entitled ATOM PROBE METHODS, which is fully incorporated herein by reference and PCT Application No. US2005/046842, Attorney Docket No. 39245-8111. WO00, filed Dec. 20, 2005, entitled LASER ATOM PROBES, which is fully incorporated herein by reference) one can steer an energy beam in a pattern while monitoring any one of a number of outputs (FIG. 1). One may also define a subset of the original pattern and re-steer the energy beam within that smaller pattern, ostensibly to improve the accuracy and/or precision of the position of the beam relative to the specimen.

Alignment techniques may include but not be limited to the use of micropositioners or positioning stages and can be manual, automatic, or some combination thereof. Examples of micropositioners can include lead-screws, bearing slides, linear actuators, stepper motors and the like. The process may include feedback of the position of the specimen and/or beam, the relative degree of interaction between the beam and the specimen, it can rely on operator input, or some combination therein. Examples of a semiautomatic technique may include a micropositioner interfaced to a computer. An operator may observe some signal indicative of the interaction of the beam and the specimen and use keyboard commands to affect the alignment. Another technique may involve an operator assisted movement coupled with an automated detection means to sense the interaction of the beam and the specimen. Alternately the alignment can be fully automated and some feedback mechanism can be used to obtain some degree of initial alignment.

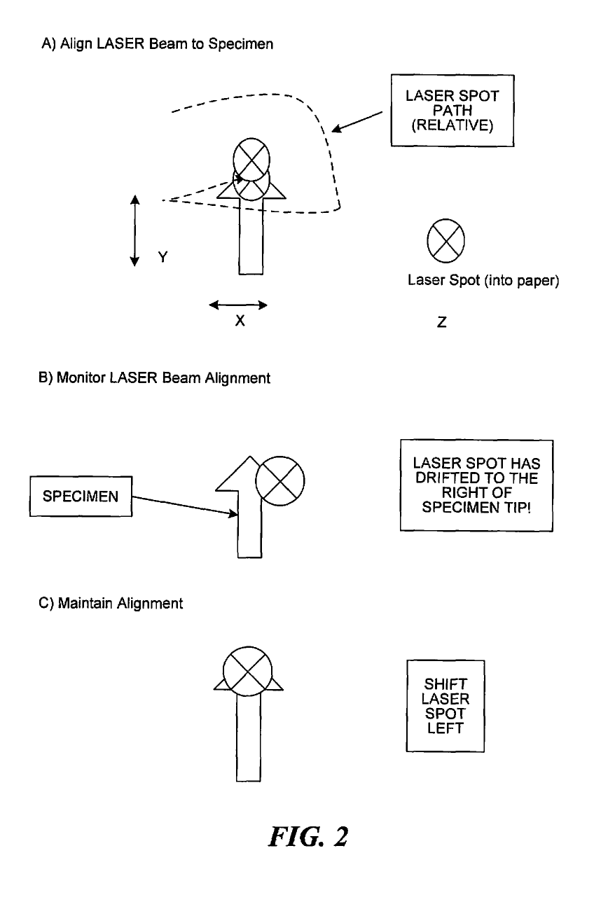

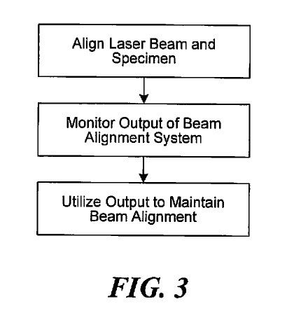

In one aspect of several embodiments of the disclosure, after initially moving the beam (or moving the specimen) and/or aligning the beam and specimen, the alignment can be automatically maintained based on one or more monitored parameters and/or the output of some sensor(s) (FIG. 2). The parameters can include but are not limited to:
Evaporation Rate (Er)
Reflection
Absorption
   The sensors can be part of a feedback loop that actively corrects for drift of the beam-to-specimen position (FIG. 3). The drift can result from changes in the beam control (focus, position, power, orientation, polarization or other means) or specimen position (erosion, deflection, expansion, contraction, thermal drift, vibration or other cause). This automated process can be performed in real time and may reduce or even eliminate the need to sweep, or re-sweep the energy beam.

What follows are embodiments specifically related to the use of laser beams. Other energy means to induce ionization including but not limited to electron beams may be utilized.

One embodiment of a method to maintain specimen and beam alignment may be as follows. The focal point of the laser beam is swept over the specimen apex in 3 dimensions (i.e., X, Y, and focus (sometimes referred to as “Z”)) while monitoring the evaporation rate from the specimen tip. The alignment is optimized once a maximum in the evaporation rate is found.

In another embodiment, a control system possibly including a CCD camera acquires an image of the diffraction pattern produced by the interaction of the laser and the specimen tip, stores the image, and continues to acquire images of the diffraction pattern. Throughout the remainder of the acquisition, the control system maintains alignment between the specimen and the laser by comparing the most recently acquired diffraction pattern with the stored diffraction pattern and can adjust the beam position, one axis at a time (if necessary), to minimize the difference between the original stored image and the recently acquired image.

If the drift is occurring faster than the diffraction pattern imaging system can correct for (e.g., resulting from a high frequency vibration), then one might also apply independent dithering functions to each beam position axis in order to improve the contrast of the diffraction pattern. Each dithering function can then be optimized, one at a time, to optimize the diffraction pattern contrast.

One may also monitor one or more of the evaporation rate (Er), the reflection, the absorption, and/or some other interaction of the beam and the specimen.

Another embodiment may be useful when analyzing arrays of specimen tips. One tip (or similar structure) may serve as the sentinel or reference for beam alignment, with the other specimen tips positioned a known distance relative to the sentinel. Once the reference is located, the other tips may be easily located.

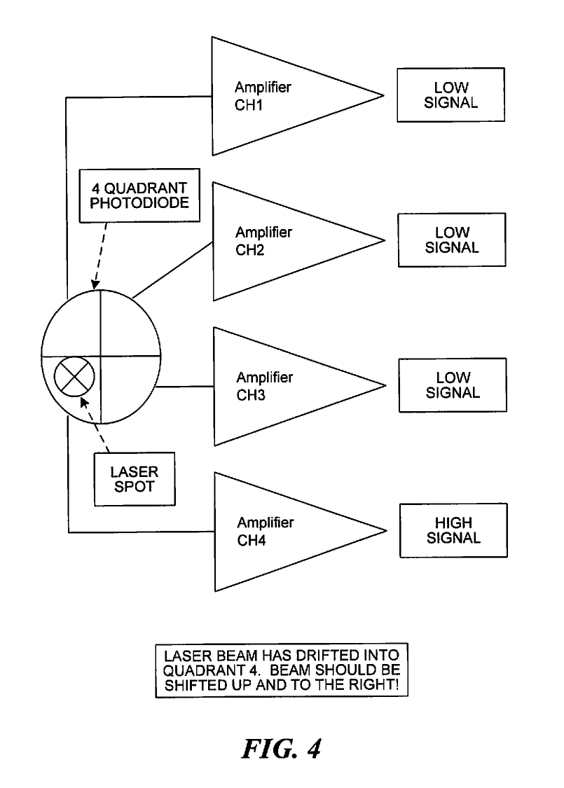

Further, one may use an object rather than a specimen and monitor the reflection, absorption (e.g. induced heat) or diffraction pattern generated by the beam-to-object interaction. One may then utilize the resulting signal to align the beam to the target specimen. This can be accomplished by interposing an object or sensor (e.g. a photodiode or photodiode array) between the specimen and the source of the beam and use it as a “targeting means” to monitor and control the beam position. Another variation of this embodiment would place the targeting means beyond or adjacent to the specimen. In another variation, the beam itself may be split, reflected or the like and a portion of the beam may serve as the beam signal to be sensed. Another variation would utilize multiple photodiodes in, for example, a four quadrant array. The output of each photodiode could be monitored to determine if the beam has drifted (FIG. 4).

In yet another variation some secondary means may be utilized to measure drift (e.g. as with an Atomic Force Microscope (AFM) tip). The AFM tip could either sense movement of the specimen or movement of a substrate coupled to the specimen. The output of either of these variations may be combined with any of the mentioned embodiments.

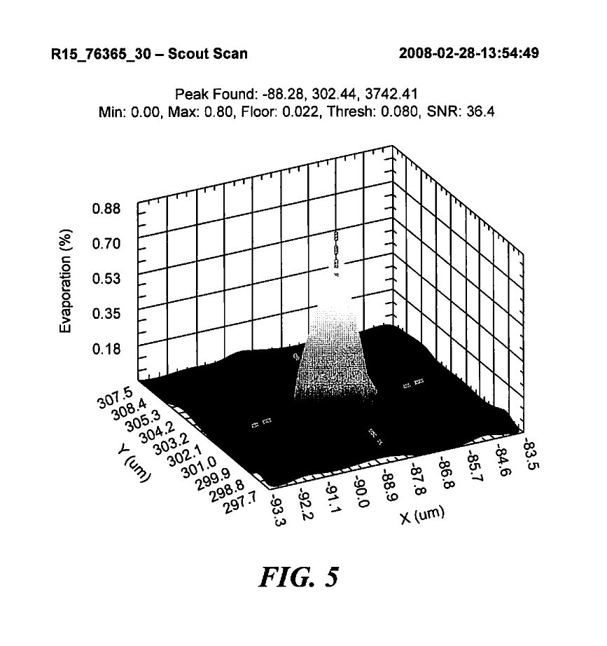

In another embodiment the beam may be aligned to a specific position and the beam may be pulsed sufficiently to yield a specific number of counts while dwelling at that particular point in space. By properly setting the count threshold based on quantum statistics or other means it is possible to improve the signal to noise ratio and reduce the effects of noise counts. By establishing a count threshold of, as an example 100 counts per pixel, the Er can be calculated at that specific point in space and be assigned to a pixel. This may be referred to as an adaptive or automatic dwell mode. Alternately, a temporal dwell duration can be selected and the number of counts at that position over a fixed duration can be stored. Further, the beam position may be incremented to an adjacent position and the acquisition sequence repeated. A two or three dimensional array or plot of the Er or counts per pixel can be generated and a maximum can be identified (see FIG. 5).

In yet another embodiment an adaptive dwell may be combined with a fixed duration. One example of this is a case wherein the count threshold is not achieved within a specified duration. Rather than remain at that point in space the position can be changed and the acquisition process repeated.

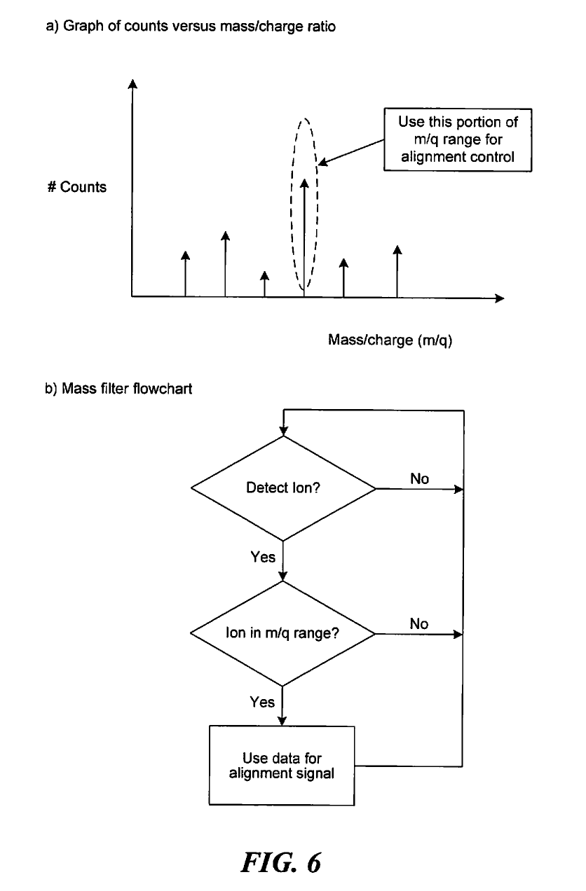

In another embodiment, collectively called the “Mass Filter™ technique”, the data from a portion or subset of the measured mass/charge spectrum may be monitored and utilized to control one or more operating parameters (FIG. 6). The TOF of an ion is affected by the mass, voltage, the distance and the charge state by the relationship:

TOF˜Distance*(Mass/(Charge*Voltage))**1/2

Rather than use the entire spectrum or range of TOF information from all detected ions during the alignment process a subset of the spectrum can be used. In one example aluminum +1 is analyzed (m=27) in a reflectron based laser atom probe. Only the ions detected with a TOF of about 1700 nanoseconds (at about +6000 volts applied to the specimen with a distance of about 40 cm between the specimen and the detector) are used to maintain alignment when acquiring data for this specimen. These correspond to a mass range of 26.9 to 27.1. Note that all of the TOF information can be recorded for a given dataset but only a portion or subset of it can be used in this embodiment as control data for the alignment process. Using a subset can result in improved performance due to the fact that the control data is less noisy and can contain fewer artifacts. Essentially the signal to noise ratio is greatly improved, hence the control signal is of higher quality and the alignment can be more accurate. Further, by constraining the control data the sensitivity of the alignment process can be increased. In one variation a range of raw TOF information is used. In another variation corrected TOF information is used. Corrections can include compensation for time of departure spread, flight path variations, specimen shape and the like. In yet another variation a range of mass or mass to charge values could be used. In another variation a combination of these and other values could be used.

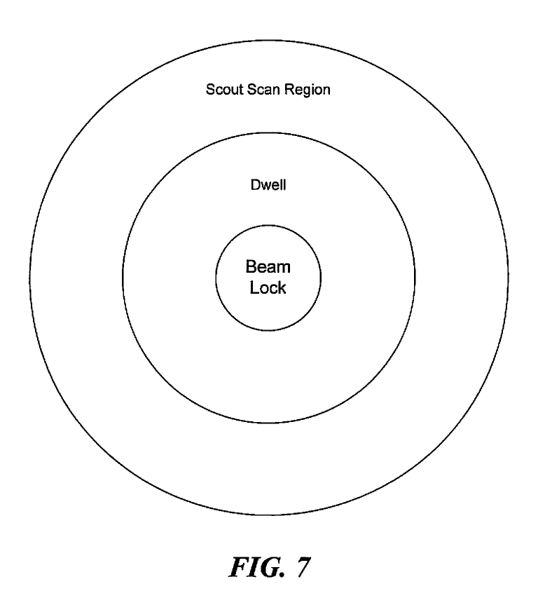

In another embodiment the alignment method may progress through different modes of operation. The initial alignment process may be considered a “scout scan”, wherein the relative position of the specimen and beam are scanned over a given area. When the alignment of the beam with respect to the specimen is considered optimal a “dwell” state may be entered. The goal of the dwell state is to maintain some degree of “beam lock” wherein the position and/or focus of the beam is maintained relatively constant yielding some degree of stability in the monitored parameters (FIG. 7). If the criteria for beam lock are not met then the scan mode may be re-entered until a new beam lock is attained. As in other embodiments the criteria used may include Er, reflection, absorption and the like.

It should be noted that the methods described herein can be applied to systems with traditional beam optics (i.e. out-of-vacuum) or those that include in-vacuum optics.

From the foregoing, it will be appreciated that specific embodiments of the invention have been described herein for purposes of illustration, but that various modifications may be made without deviating from the invention. Additionally, aspects of the invention described in the context of particular embodiments may be combined or eliminated in other embodiments. Although advantages associated with certain embodiments of the invention have been described in the context of those embodiments, other embodiments may also exhibit such advantages. Additionally, not all embodiments need necessarily exhibit such advantages to fall within the scope of the invention. Accordingly, the invention is not limited except as by the appended claims.

I/We claim:

1. A method for aligning an energy beam to an object in an atom probe comprising:
monitoring at least one parameter indicative of an interaction between said energy beam and said object;
generating a signal in response to said interaction of said energy beam and said object;
utilizing the signal to effectuate control of the alignment of said energy beam to said object.

2. The method of claim 1 wherein said signal is a position control signal.

3. The method of claim 1 wherein said signal is used to control the energy beam.

4. The method of claim 2 wherein said position control signal is applied to control the energy beam position.

5. The method of claim 2 wherein said position control signal is applied to control the position of the object.

6. The method of claim 1 wherein the object is a specimen to be analyzed.

7. The method of claim 1 wherein the energy beam is a laser beam.

8. The method of claim 1 wherein the parameter is chosen from the group of evaporation rate, reflection, absorption, diffraction pattern, or mass/charge spectrum.

9. A method for maintaining the alignment of an energy beam to a specimen in an atom probe comprising:
aligning a beam to the specimen;
monitoring a parameter indicative of the alignment of the beam and the specimen;
utilizing the parameter to control the alignment of the energy beam to the specimen using the parameter.

10. The method of claim 9 wherein said energy beam is a laser beam.

11. The method of claim 9 wherein the parameter is chosen from the group of evaporation rate, reflection, absorption, diffraction pattern, or mass/charge spectrum.
